(19) United States
(12) Patent Application Publication
(10) Pub. No.: US 2015/0278981 A1
(43) Pub. Date: Oct. 1, 2015

(54) Avoiding Sending Unchanged Regions to Display

(71) Applicant: Tomas G. Akenine-Moller, Lund (SE)

(72) Inventor: Tomas G. Akenine-Moller, Lund (SE)

(21) Appl. No.: 14/227,228

(22) Filed: Mar. 27, 2014

(51) Int. Cl. G06T 1/20; G06T 1/60

(52) U.S. Cl. CPC G06T 1/20; G06T 1/60

(57) ABSTRACT

In accordance with some embodiments, in a sort last architecture, it is determined whether each of a plurality of portions of a screen display are constant from one frame to the next. A frame may be divided into tiles that may be rectangular regions of pixels. If the tiles are constant then the tile need not be sent to the display.

### BACKGROUND

This relates to graphics processing.

The graphics system and its graphics processors should ideally reduce power usage as much as is feasible. In the extended DisplayPort specification (eDP), version 1.0/1.5, partial updates of the screen display are authorized. This means that if part of the screen has not changed from one frame to another, that part need not be sent to the display. Other standards and operating system (on mobile devices, for example) may have similar features. These types of techniques reduce the bandwidth used for transfers to display, and hence also reduce power consumption. The problem is that it may not be easy to detect which regions are constant or unchanged from one frame to the next. While there are some techniques for doing this in certain types of systems, in other types of systems, called sort last, there is currently no such technique.

Sorting refers to sorting primitives to the screen so that parallelism can be extracted and exploited. The primitives may be triangles or quadrilaterals that represent portions of an object to be displayed. This sorting can occur at many different places during the conventional graphics pipeline. In sort last, the sorting occurs after rasterization of the primitives into pixels, samples or pixel fragments.

### BRIEF DESCRIPTION OF THE DRAWINGS

Some embodiments are described with respect to the following figures:

FIG. 1 is a depiction of an extended DisplayPort compliant system according to one embodiment;

FIG. 2 is a depiction of a graphics pipeline according to one embodiment;

FIG. 3 is a depiction of a color buffer system according to one embodiment;

FIG. 4 is a flow chart for one embodiment;

FIG. 5 is a system depiction for one embodiment; and

FIG. 6 is a front elevational view of one embodiment.

### DETAILED DESCRIPTION

In accordance with some embodiments, in a sort last architecture, it is determined whether each of a plurality of portions of a screen display are constant from one frame to the next. A frame may be divided into portions called tiles that may be confined within a closed region in one embodiment. The tile may be rectangular in one embodiment and in one particular embodiment it contains 32×32 pixels.

For each tile, a hash is stored. A hash function is an algorithm that maps data of arbitrary length to data of a fixed length. Hashes are the values returned by the hash function. In an embodiment with tiles of 32×32 pixels, the hash may be a 64-bit number.

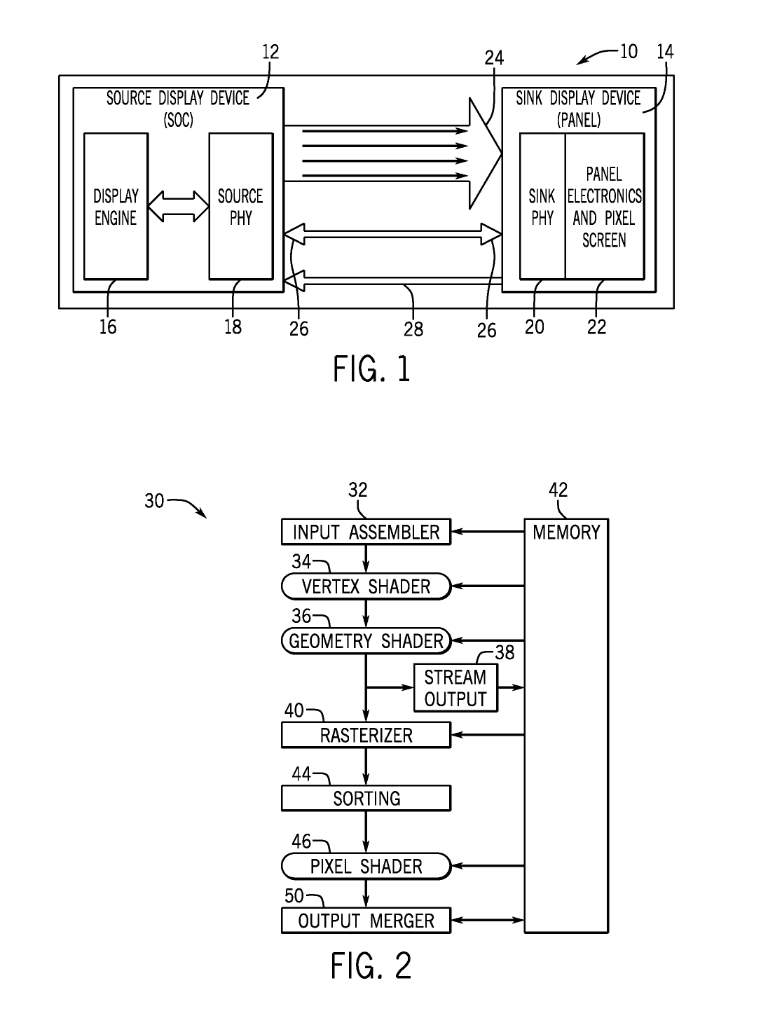

Referring to FIG. 1, a physical layer interface 10, in one embodiment according to the extended DisplayPort (eDP) standard version 1.0/1.5 (2008/2013), includes a source display device 12, such as a system on a chip (SOC), communicating over the interface with a sink display device or panel 14. The display device 12 includes the display engine 16 and the source physical layer or PHY 18. The connection to the sink display device is over an interface that includes a main link 24, including four isochronous streams, a side channel or auxiliary channel 26 for a link and device management, and a hot plug detect (HPD) 28 that includes plug state and interrupt requirements. The sink display device or panel 14 includes a sink PHY 20 and the panel electronics and pixel screen 22, in some embodiments.

Referring to FIG. 2, a Direct3D 10 pipeline 30 is illustrated in accordance with one embodiment. Pipelines other than the Direct3D programmable pipeline may also be used such as DirectX and OpenGL to mention two examples. This pipeline is designed for generating graphics for real time gaming applications, for example. The input-assembler stage 32 is responsible for fetching data to the pipeline. The vertex shader stage 34 processes the vertices by performing operations such as transformations, skinning and lighting. The geometry shader 36 processes entire primitives, and may even generate new primitives that are sent downstream in the pipeline. The stream-output stage 38 streams primitive data from the pipeline to the memory 42 on its way to the rasterizer. The data can be streamed out and/or passed to the rasterizer 40. Data streamed to the memory can be recirculated back into the pipeline as input data or read back from a central processing unit (not shown).

The rasterizer stage is responsible for clipping primitives, and determining which samples are inside the primitive being rendered, and for those the pixel shader 46 is invoked. In a sort last architecture, sorting 44 occurs after rasterizing. The pixel backend or output merger stage 50 combines various types of output data such as pixel shader values, depth and stencil information with contents of the rendered target and the depth/stencil buffers to generate the final pipeline result.

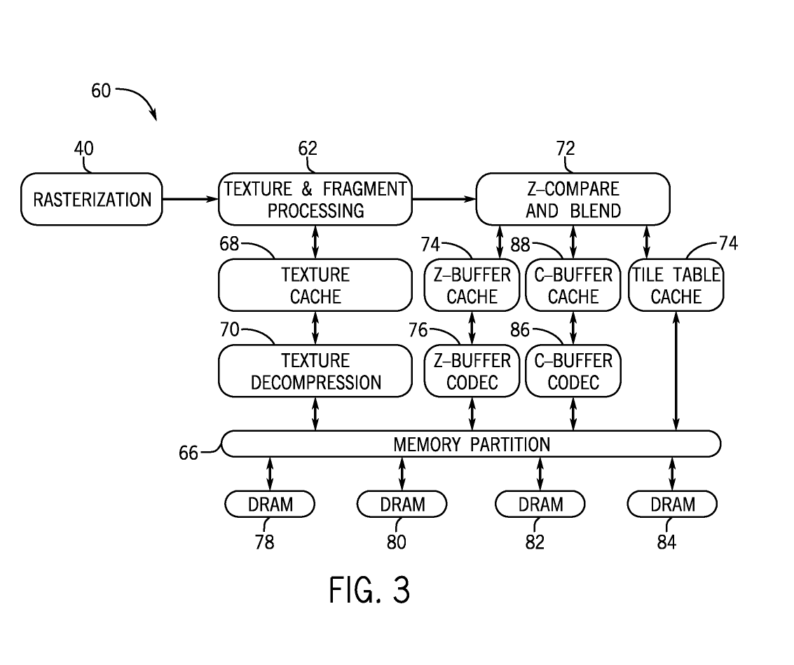

In FIG. 3, a graphics processor 60 may include a rasterization pipeline including a rasterizer 40, a texture and fragment processing unit 62, and a depth or Z compare and blend unit 72. Each of these units may be implemented in whole or in part by software or hardware in some embodiments.

The texture and fragment processing unit 62 is coupled to a texture cache 68. The texture cache 68 is in turn coupled to a memory partition 66 through a texture decompression module 70. Thus, texture information stored in the texture cache 68 may be decompressed between the memory partition and the texture cache 68.

The depth compare and blend unit 72 is coupled to a depth (z) buffer cache 74, a color (c) buffer cache 88 and a tile table cache 74. In turn, the depth buffer cache 74 is coupled to the memory partition 66 through the depth buffer coder/decoder (codec) 76. Likewise, the color buffer cache 88 couples to the memory partition 66 through the color buffer coder/decoder (codec) 86. The memory partition 66 may be coupled to dynamic random access memory (DRAM) 78, 80, 82 and 84 which may be part of system memory. In some embodiments, a unified cache may be used that includes the texture cache, the depth buffer cache and the color buffer cache.

In some embodiments, a unified codec may replace the units 70, 76, and 86. Various configurations are described in further detail in the article, Floating Point Buffer Compression in a Unified Codec Architecture by Ström, et al. Graphics Hardware (2008).

All color buffer accesses usually go through the color buffer cache in order to save bandwidth. For a 16×16 tile for example, several cache lines are needed to store the colors in such a tile. The accumulation to the hash can be done in different ways.

In one embodiment, the color content of cache lines corresponding to a certain tile may be accumulated into that tile's hash on all writes to the cache lines. This means that even colors of objects, that may be occluded later on, will accumulate their content to the cache. This may be done since there is no way of knowing in a sort last fragment architecture (also known as an immediate renderer) when the frame is finished rendering for a certain tile. The values written to a cache line may be accumulated into a corresponding hash that belongs to a tile that the cache line belongs.

The hash needs to be stored as well. For a 1920×1080 display with 32×32 tiles, for example, 1920×1080/(32×32)*64 bits equals 16 k bytes. Since both the current and the previous hashes may be stored, this doubles the memory usage to 32 k bytes. These hashes may be accessed through a cache as well as stored in an on-chip memory. This amounts to rather little memory that could be stored directly in a fixed amount of fast memory (e.g., SRAM) or accessed through an even smaller cache. Using a cache is the most realistic option, since several render targets could be handled in parallel.

The hash function may be a cryptographic hash function (such as SHA-1), or done via a nonlinear table lookup, or via checksum functions, or via other methods. As long as they provide few collisions, and ideally, if one bit is changed in the input data, many bits are changed in the resulting hash.

In one embodiment, after rendering, the current content in the color buffer cache is examined. The content of the cache may commonly be flushed when the frame is finished. The hash may be accumulated as usual for all data in the cache, if not done already, and then compared to the hashes from the previous frame. If the hashes are the same, then there is no need to flush the cache back to memory. Avoiding flushing saves bandwidth and reduces power consumption.

In addition, the hash may be used in a different way as well. Assume that we have finished rendering to a render target denoted R, and all hashes for the render target have been computed. Now, assume that the next frame is being rendered, and that R is currently being rendered to. Instead of clearing the render target, we could keep the content from the previous frame, and just mark all tiles as cleared. Now, when we render to a tile in the render target, some cache lines will need to be evicted at some point from the color cache. If the hash of the render target of the current frame for the tile corresponding to the cache lines is the same as the previous frame, then we can just skip evicting the data from the cache because it is correct in the main memory. The corresponding cache lines can therefore immediately be used for other data.

After a frame has finished rendering, the algorithm may run through the hashes of each tile of the image, looking at the current hash and the previous hash for the same tile. If they are the same, then the color content need not be sent to the display. In an extended DisplayPort compliant system (or in another system with a similar feature), a partial frame update may be sent to the display. Tiles whose hashes are constant from one frame to the next are not sent to the display.

In addition, if the surfaces multi-sampled, then there is a resolve pass before the colors are sent to the display. However, if the hashes are the same, then the resolve pass, which uses bandwidth and compute cycles, can be avoided and further bandwidth and compute cycles can be saved in some embodiments. This, in turn, saves energy.

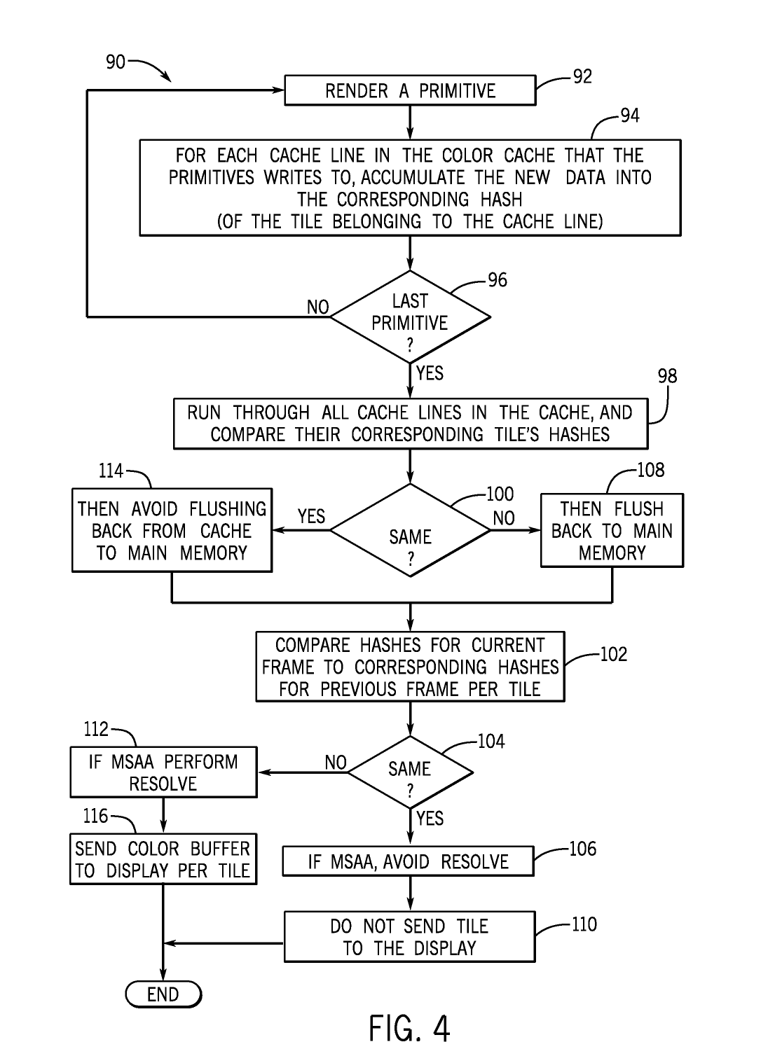

In accordance with some embodiments, a sequence 90, shown in FIG. 4, for implementing a sort last architecture with selective sending of tiles to display may be implemented in software, firmware and/or hardware. In software and firmware embodiments it may be implemented by computer executed instructions stored in one or more non-transitory computer readable media such as magnetic, optical or semiconductor storages. In one embodiment the instructions may be stored in the memory 42.

The sequence 90 shown in FIG. 4 begins by rendering a primitive as indicated in block 92. For each cache line in the color cache that the primitive writes to, accumulate the new data into the corresponding hash of the tile belonging to the cache line, as indicated in block 94. Any hash function may be utilized for this purpose. A check at diamond 96 determines if this is the last primitive. If so, run through all cache lines in the cache and compare their corresponding tile's hashes as indicated in block 98.

If the tile's hashes are the same (diamond 100), then avoid flushing back the corresponding cache lines from cache to main memory as indicated in block 114.

On the other hand, if the tile's hashes are not the same, then flush back to main memory as indicated in block 108.

In either case, whether the hashes are the same or not, the hashes for the current frame are compared to the corresponding hashes for the previous frame per tile as indicated in block 102. This is done for the entire render target, image, or frame buffer. If they are the same (diamond 104) and this is a multi-sampled antialiasing (MSAA) embodiment, the resolve pass may be avoided as well, as indicated in block 106. Then the tile is not sent to the display as indicated in block 110. If they are not the same (diamond 104) and multi-sampled antialiasing is used, then its resolve pass is also used in such cases as indicated in block 112. Then the color buffer is sent to the display per tile as indicated in block 116.

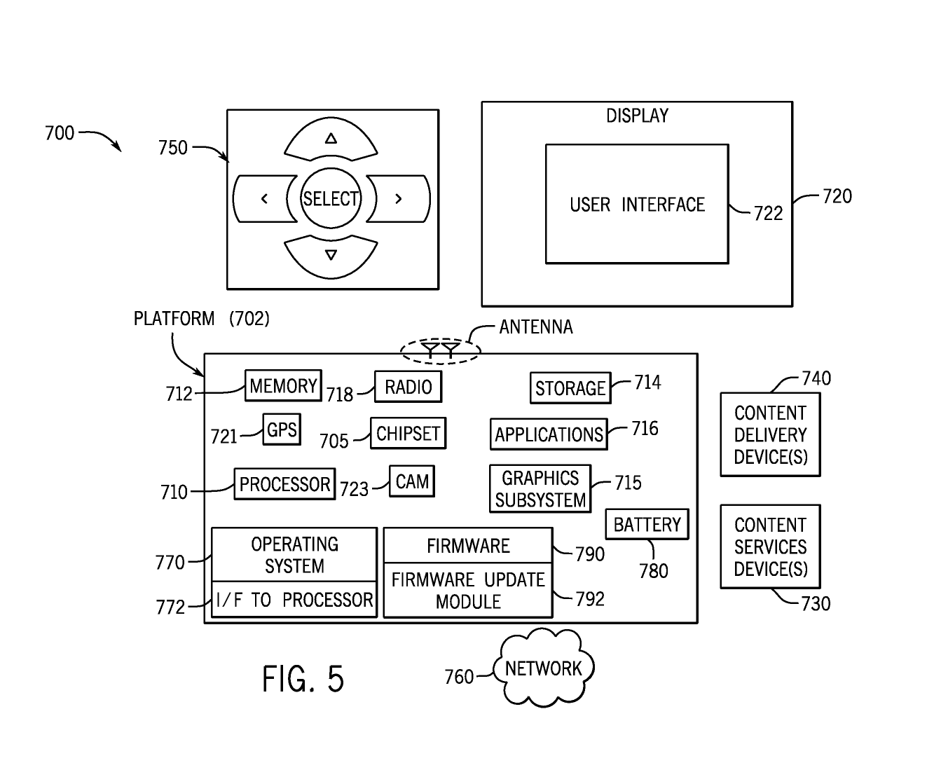

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequence of FIG. 4, together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

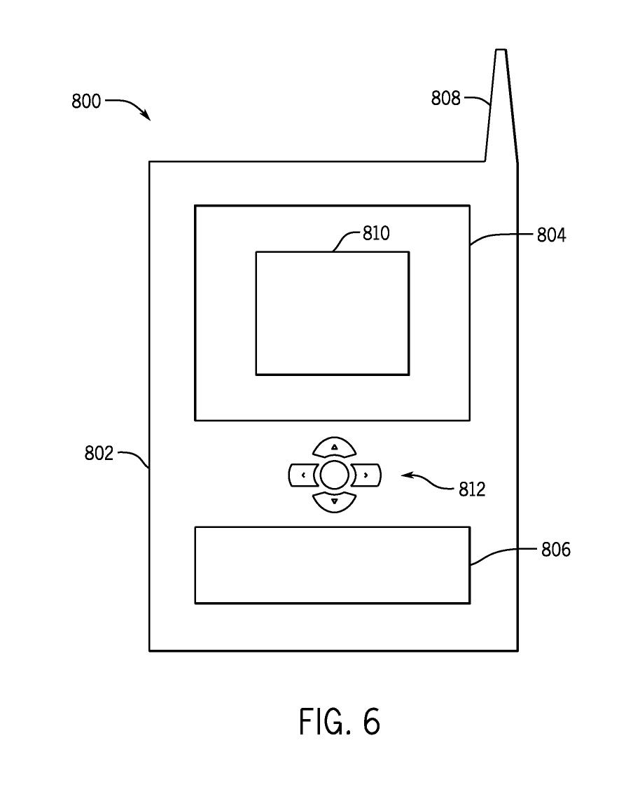

As described above, system 700 may be embodied in varying physical styles or form factors. FIG. 6 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The processor 710 may communicate with a camera 722 and a global positioning system sensor 720, in some embodiments. A memory 712, coupled to the processor 710, may store computer readable instructions for implementing the sequences shown in FIG. 4 in software and/or firmware embodiments.

As shown in FIG. 6, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

The following clauses and/or examples pertain to further embodiments:

One example embodiment may be a method comprising using a graphics processor to divide a frame into a plurality of tiles, determining a hash for each of said tiles, comparing the hashes for each tile to hashes for the same tiles in a previous frame; and only sending a tile to a display if the hashes are not the same. The method may also include wherein, only if the hashes are not the same, sending the content of a tile to the display. The method may also include only doing a multi-sampled anti-aliasing resolve for each tile if the hashes are not the same. The method may also include wherein if the hashes are the same, refraining from flushing the corresponding cache lines in the color cache back to main memory. The method may also include refraining from flushing cache lines, in the color cache, whose corresponding hash is the same as the hash for the previous frame. The method may also include accumulating the values written to a cache line into a corresponding hash that belongs to a tile that the cache line belongs. The method may also include implementing an extended display port partial screen update. The method may also include using a sort last architecture. The method may also include determining the hash using a cryptographic hash function. The method may also include determining the hash using a nonlinear table lookup or checksum functions.

In another embodiment may be one or more non-transitory computer readable media storing instructions executable by a processor to perform a sequence comprising dividing a frame into a plurality of tiles, determining a hash for each of said tiles, comparing the hashes for each tile to hashes for the same tiles in a previous frame, and only sending a tile to a display if the hashes are not the same. The media may also include wherein only if the hashes are not the same, sending the content of a tile to the display. The media may include only doing a multi-sampled anti-aliasing resolve for each tile if the hashes are not the same. The media may also include wherein if the hashes are the same, refraining from flushing the corresponding cache lines in the color cache back to main memory. The media may include refraining from flushing cache lines, in the color cache, whose corresponding hash is the same as the hash for the previous frame. The media may include accumulating the values written to a cache line into a corresponding hash that belongs to a tile that the cache line belongs. The media may include implementing an extended display port partial screen update.

Another example embodiment may be an apparatus comprising a processor to divide a frame into a plurality of tiles, determine a hash for each of said tiles, compare the hashes for each tile to hashes for the same tiles in a previous frame, and only send a tile to a display if the hashes are not the same, and a storage coupled to said processor. The apparatus may include wherein only if the hashes are not the same, said processor to send the content of a tile to the display. The apparatus may include said processor to only do a multi-sampled anti-aliasing resolve for each tile if the hashes are not the same. The apparatus may include said processor if the hashes are the same, to refrain from flushing the corresponding cache lines in the color cache back to main memory. The apparatus may include said processor to refrain from flushing cache lines, in the color cache, whose corresponding hash is the same as the hash for the previous frame. The apparatus may include said processor to accumulate the values written to a cache line into a corresponding hash that belongs to a tile that the cache line belongs. The apparatus may include said processor to implement an extended display port partial screen update. The apparatus may include said processor having a sort last architecture. The apparatus may include said processor to determine the hash using a cryptographic hash function. The apparatus may include said processor to determine the hash using a nonlinear table lookup or checksum functions. The apparatus may include a display communicatively coupled to the processor. The apparatus may include a battery coupled to the processor. The apparatus may include firmware and a module to update said firmware.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
using a graphics processor to divide a frame into a plurality of tiles;
determining a hash for each of said tiles;
comparing the hashes for each tile to hashes for the same tiles in a previous frame; and
only sending a tile to a display if the hashes are not the same.

2. The method of claim 1 wherein, only if the hashes are not the same, sending the content of a tile to the display.

3. The method of claim 1 including only doing a multi-sampled anti-aliasing resolve for each tile if the hashes are not the same.

4. The method of claim 1 wherein if the hashes are the same, refraining from flushing the corresponding cache lines in the color cache back to main memory.

5. The method of claim 1, including refraining from flushing cache lines, in the color cache, whose corresponding hash is the same as the hash for the previous frame.

6. The method of claim 1, including accumulating the values written to a cache line into a corresponding hash that belongs to a tile that the cache line belongs.

7. The method of claim 1 including implementing an extended display port partial screen update.

8. The method of claim 1 including using a sort last architecture.

9. The method of claim 1, including determining the hash using a cryptographic hash function.

10. The method of claim 1, including determining the hash using a nonlinear table lookup or checksum functions.

11. One or more non-transitory computer readable media storing instructions executable by a processor to perform a sequence comprising:
dividing a frame into a plurality of tiles;
determining a hash for each of said tiles;
comparing the hashes for each tile to hashes for the same tiles in a previous frame; and
only sending a tile to a display if the hashes are not the same.

12. The media of claim 11 wherein, only if the hashes are not the same, sending the content of a tile to the display.

13. The media of claim 11 including only doing a multi-sampled anti-aliasing resolve for each tile if the hashes are not the same.

14. The media of claim 11 wherein if the hashes are the same, refraining from flushing the corresponding cache lines in the color cache back to main memory.

15. The media of claim 11, including refraining from flushing cache lines, in the color cache, whose corresponding hash is the same as the hash for the previous frame.

16. The media of claim 11, including accumulating the values written to a cache line into a corresponding hash that belongs to a tile that the cache line belongs.

17. The media of claim 11, including implementing an extended display port partial screen update.

18. An apparatus comprising:
a processor to divide a frame into a plurality of tiles, determine a hash for each of said tiles, compare the hashes for each tile to hashes for the same tiles in a previous frame, and only send a tile to a display if the hashes are not the same; and
a storage coupled to said processor.

19. The apparatus of claim 18 wherein, only if the hashes are not the same, said processor to send the content of a tile to the display.

20. The apparatus of claim 18, said processor to only do a multi-sampled anti-aliasing resolve for each tile if the hashes are not the same.

21. The apparatus of claim 18, said processor if the hashes are the same, to refrain from flushing the corresponding cache lines in the color cache back to main memory.

22. The apparatus of claim 18, said processor to refrain from flushing cache lines, in the color cache, whose corresponding hash is the same as the hash for the previous frame.

23. The apparatus of claim 18, said processor to accumulate the values written to a cache line into a corresponding hash that belongs to a tile that the cache line belongs.

24. The apparatus of claim 18, said processor to implement an extended display port partial screen update.

25. The apparatus of claim 18, said processor having a sort last architecture.

26. The apparatus of claim 18, said processor to determine the hash using a cryptographic hash function.

27. The apparatus of claim 18, said processor to determine the hash using a nonlinear table lookup or checksum functions.

28. The apparatus of claim 18 said processor to store content from a previous frame, mark the content as cleared, if a hash of a render target of a current frame for a tile is the same as a hash for the previous frame, and avoid evicting data from the cache to memory and just releasing the corresponding cache line(s).

29. The apparatus of claim 18 including a battery coupled to the processor.

30. The apparatus of claim 18 including firmware and a module to update said firmware.
